(19) United States
(12) Patent Application Publication
(10) Pub. No.: US 2022/0360670 A1
(43) Pub. Date: Nov. 10, 2022

(54) SYSTEM AND METHOD TO ENABLE CHARGING AND POLICIES FOR A UE WITH ONE OR MORE USER IDENTITIES

(71) Applicant: NEC Corporation, Minato-ku, Tokyo (JP)

(72) Inventors: Shubhranshu SINGH, Heidelberg (DE); Toshiyuki TAMURA, Tokyo (JP); Iskren IANEV, Lower Earley (GB)

(73) Assignee: NEC Corporation, Minato-ku, Tokyo (JP)

(21) Appl. No.: 17/626,959

(22) PCT Filed: Nov. 6, 2020
(86) PCT No.: PCT/JP2020/041535

§ 371 Date: Jan. 13, 2022

(30) Foreign Application Priority Data
Nov. 11, 2019 (EP) 19208398.8

(51) Int. Cl. H04M 15/00

(52) U.S. Cl. CPC H04M 15/7652; H04M 15/66

(57) ABSTRACT

This disclosure proposes a network function node in a core network, comprising: means for receiving, from User Equipment, UE, a non access stratum, NAS, message including identity information for the UE, and a plurality of user identity information, each of which includes a user identifier for a user that uses the UE; and means for sending, to a policy control and charging function node in the core network, the plurality of the user identity information for creating a Policy and Charging Control, PCC, rule based on the plurality of the user identity information.

### TECHNICAL FIELD

The present disclosure relates to a communication system. The disclosure has particular but not exclusive relevance to wireless communication systems and devices thereof operating according to the 3rd Generation Partnership Project (3GPP) standards or equivalents or derivatives thereof. The disclosure has particular although not exclusive relevance to charging and policies for user equipment/user identities in the so-called ‘5G’ (or ‘Next Generation’) systems.

### LIST OF ABBREVIATIONS

3GPP 3^{rd} Generation Partnership Project

5GC 5^{th} Generation Core Network

5GS 5^{th} Generation System

AF Application Function

AM Policy Access and Mobility Management

AMF Access and Mobility Management Function

API Application Programming Interfaces

CDR Charging Data Record

CHF Charging Function

DNN Data Network Name

EPS Evolved Packet System

GPRS General Packet Radio Services

GTP-C GPRS Tunneling Protocol

HOL Head of Line

H-PCF Home Policy Control Function

HTTPS Hyper Text Transfer Protocol Secure

MNO Mobile Network Operator

NEF Network Exposure Function

NF Network Function

NRF Network Repository Function

PCC Policy and Charging Control

PCF Policy Control Function

PDU Protocol Data Unit

QoS Quality-of-Service

QUIC Quick UDP Internet Connections

REST Representational State Transfer

SDL Shared Data Layer

SLA Service level agreement

SM Session Management

SMF Session Management Function

S-NSSAI Single Network Slice Selection Assistance Information

SUPI Subscription Permanent Identifier

TCP Transport Control Protocol

TLS Transport Layer Security

TTI Transmission Time Interval

UDM Unified Data Management

UDR Unified Data Repository

UPF User Plane Function

UE User Equipment

UICC Universal Integrated Circuit Card

(U)SIM Universal Subscriber Identity Module

V-PCF Visited Policy Control Function

VPLMN Visited Public Land Mobile Network

### BACKGROUND ART

For the purposes of the present document, the terms and definitions given in 3GPP Technical Report (TR) 21.905 [1] and the following apply. A term defined in the present document takes precedence over the definition of the same term, if any, in 3GPP TR 21.905 [1].

User: As defined in 3GPP TR 21.905 [1]: An entity, not part of the 3GPP System, which uses 3GPP System services. Example: a person using a 3GPP System mobile station as a portable telephone.

user identity: information representing a user in a specific context. A user can have several user identities, e.g. a User Identity in the context of his profession, or a private User Identity for some aspects of private life, see 3GPP TR 22.904[5].

user identifier: a piece of information used to identify one specific User Identity in one or more systems, see 3GPP TR 22.904[5].

user identity profile: A collection of information associated with the User Identities of a user, see 3GPP TR 22.904[5].

### SUMMERY OF INVENTION

It is important that the 5G system (5GS) allows for creation and utilization of user-specific identities in order to provide enhanced user experience, optimized performance and offer services to devices and users that are not part of the operator's 3GPP network. There are multiple scenarios where user-specific identities are applicable and required to be supported by the 5G system. For example, there are some scenarios where one or more users (i.e. humans) share one UE, and one or more users (i.e. devices) are behind one gateway UE and one or more users (i.e. gaming applications) are running on the same UE and each are treated as a different user. These are further discussed in details in [5].

Currently 5GS enables charging on per subscription basis with respective UE ID. However, for the above mentioned example use cases, there is no way for the 5G system e.g. the PCF, the SMF, the UPF, the CHF to create, report, manage and/or provide policies and charging information corresponding to different Users sharing this particular UE i.e. policies and charging enabler, to the granularity of individual user identifier(s).

According to an aspect of the present disclosure, network function node in a core network, includes: means for receiving, from User Equipment, UE, a non access stratum, NAS, message including identity information for the UE, and a plurality of user identity information, each of which includes a user identifier for a user that uses the UE; and means for sending, to a policy control and charging function node in the core network, the plurality of the user identity information for creating a Policy and Charging Control, PCC, rule based on the plurality of the user identity information.

According to another aspect of the present disclosure, a policy control and charging function node in a core network, includes: means for receiving, from a network function node in the core network, a plurality of a user identity information, each of which includes a user identifier for a user that uses user equipment, UE; means for creating a Policy and Charging Control, PCC, rule based on the plurality of the user identity information; and means for sending, to the network function node, the PCC rule.

According to another aspect of the present disclosure, a method for a network function node in a core network, the method includes: receiving, from User Equipment, UE, a non access stratum, NAS, message including identity information for the UE, and a plurality of user identity information, each of which includes a user identifier for a user that uses the UE; and sending, to a policy control and charging function node in the core network, the plurality of the user identity information for creating a Policy and Charging Control, PCC, rule based on the plurality of the user identity information.

According to another aspect of the present disclosure, a method for a policy control and charging function node in a core network, the method includes: receiving, from a network function node in the core network, a plurality of a user identity information, each of which includes a user identifier for a user that uses user equipment, UE; creating a Policy and Charging Control, PCC, rule based on the plurality of the user identity information; and sending, to the network function node, the PCC rule.

### BRIEF DESCRIPTION OF DRAWINGS

FIG. 1 is a flow for the Multi-User SM Policy Association Establishment procedure.

FIG. 2 is a flow for the Multi-User SM Policy Association Establishment procedure.

FIG. 3 is a flow for the UE Policy Association Establishment where multiple Users per UE 1 are involved.

FIG. 4 is an enhanced procedure where the AF 8 requests to become the chargeable party for the session to be set up by sending the Nnef_ChargeableParty_Create request message.

FIG. 5 is a schematically illustration of a mobile (cellular or wireless) telecommunication system to which the above example embodiments are applicable.

FIG. 6 is a block diagram illustrating the main components of the UE (mobile device 1) shown in FIG. 5.

FIG. 7 is a block diagram illustrating the main components of an exemplary (R)AN node 9 (base station) shown in FIG. 5.

FIG. 8 is a block diagram illustrating the main components of a generic core network node (or function).

### DESCRIPTION OF EMBODIMENTS

Example Aspect 1: Multi-User SM Policy Association Establishment for Cases where Multiple Users per UE are Involved

This example aspect discloses the following new functions when a UE 1 sends the PDU Session Establishment Request message with user identifier(s) to the AMF 2.
The 5GC provides the PCC authorization per user identifier(s) basis.
The 5GC provides a PCC policy to the PDU session based on an associated user identifier(s) basis.
The 5GC provides a CDR, Charging Data Record, based on a charging policy specific to the user identifier(s).

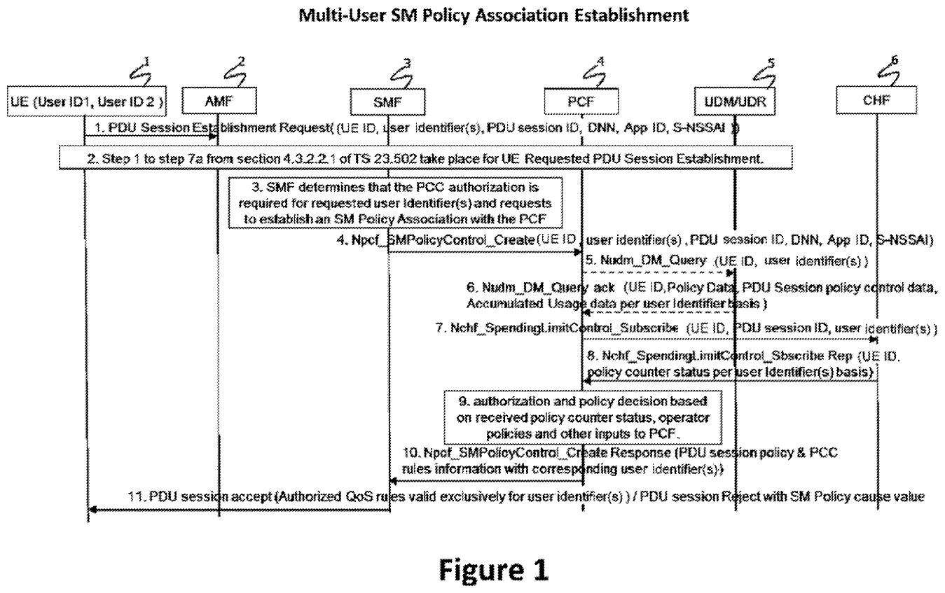

FIG. 1 explains the flow for the Multi-User SM Policy Association Establishment procedure.

Step 1: The UE 1 sends the PDU Session Establishment Request message to the AMF 2 with user identifier(s) which represent the users of UE 1 (e.g. User ID1 and User ID2).

Step 2: Step 1 to step 7a from section 4.3.2.2.1 of TS 23.502 [3] take place for UE Requested PDU Session Establishment. The AMF 2 sends the Nsmf_PDUSession_CreateSMContext Request to the SMF 3 where the AMF 2 includes the user identifier(s) for which the PDU Session is to be established. When the SMF 3 retrieves the Session Management Subscription data that has an indication whether the PDU session being established needs per user PCC policy (e.g. per User ID1 or User ID2 represented by their user identifier(s)) or not. i.e., the UDM 5 manages the new Session Management Subscription data per PDU session and per UE 1 indicating whether the UE 1 needs per user PCC policy or not. If it is needed, then the PCC rule can be assigned per user basis (e.g. per User ID1 or per User ID2 represented by their user identifier(s)) and this make it possible to (1) perform PCC authorization per user basis, (2) apply PCC policy per user basis so that QoS control per user (e.g. User ID1 or User ID2 represented by their user identifier(s)) would be possible, and (3) generate a CDR based on the PCC rule per user.

Step 3: In scenarios when the SMF 3 receives PDU session create request with one or more user identifier(s), the SMF 3 determines that the PCC authorization is required, and thus requests to establish an SM Policy Association with the PCF 4. The PCF 4 can be chosen by the SMF 3 taking into account the user identifier(s) received in the PDU Session Establishment Request message from the UE 1.

Step 4: The SMF 3 sends to the PCF 4 a Npcf_SMPolicyControl_Create message including new/additional parameters such as user identifier(s), PDU session ID, DNN, App ID, and/or S-NSSAI. These parameters indicate to the PCF 4 that SM policy creation is required for the session with the provided PDU session ID associated with User(s) (i.e. user identifier(s)).

Step 5: If the PCF 4 does not have policy related subscriber information, the PCF 4 sends the Nudr_DM_Query request message to the UDM 5 including the user identifier(s).

Step 6: The UDM 5 sends the Nudr_DM_Query response message to the PCF 4 including Policy Data specific to the user identifier(s). The UDM 5 can provide this information as the UDM 5 manages Policy Data per combination of the SUPI (i.e. UE ID) and the user identifier(s) in addition to the Policy Data per SUPI.

Step 7: The PCF 4 sends the Nchf_SpendingLimitControl_Subscribe Request message to the CHF 6 to invoke an Initial or intermediate Spending Limit Report Retrieval including the SUPI and the user identifier(s).

Step 8: The CHF 6 sends the Nchf_SpendingLimitControl_Subscribe Response message to the PCF 4 with Status of the requested subscribed policy counters for the user (i.e., user identifier) and the SUPI (i.e., subscriber) combination in the Event Information, Pending policy counter statuses and their activation times, for all policy counter(s) available for the user (i.e., user identifier) and SUPI (i.e., subscriber) combination. The CHF 6 can provide this information as the CHF 6 manages Spending Limit Report related information per combination of the SUPI and the user identifier in addition to the Spending Limit Report related information per SUPI.

Step 9: PCC authorization and policy decision take place in the PCF 4 based on received parameters from the SMF 3/UDM 5/CHF 6. The PCC authorization may fail when a validation condition is not satisfied.

Step 10: The PCF 4 sends the Npcf_SMPolicyControl_Create response message to the SMF 3. If the PCC authorization failed in the PCF 4 due to an invalidity specific to the user, then Npcf_SMPolicyControl_Create response message includes a cause value indicating that “PCC authorization specific to user failed”.

Step 11: Based on received feedback from the PCF 4 in the Npcf_SMPolicyControl_Create Response message, the SMF 3 sends the PDU Session Accept message to the UE 1 including Authorized QoS rules valid exclusively for user identifier(s)). On the other hand, if the SMF 3 receives the cause value indicating that “PCC authorization specific to user failed”, the SMF 3 sends the PDU Session Reject message with a SM cause value “PCC authorization specific to user failed”. If the UE 1 receives the PDU Session Reject message with the SM cause value “PCC authorization specific to user failed” from the SMF 3, the UE 1 shall apply this failure only to this user identifier. i.e., this failure does not affect any other user identifier(s).

Example Aspect 2: AM Policy Association Establishment in Order to Enable Policies and Charging where Multiple Users per UE are Involved

This example aspect discloses the following new functions when AM Policy Association is established between the AMF 2 and the (V-)PCF 41.
The 5GC provides an AM Policy and related charging treatment per UE 1 and associated user identifier(s) basis.

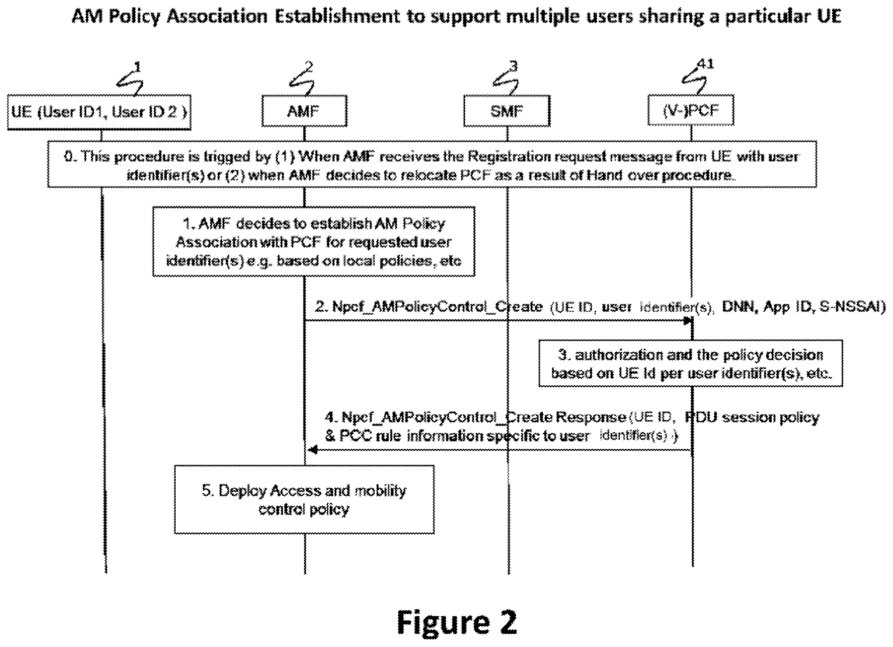

The FIG. 2 explains the flow for the Multi-User SM Policy Association Establishment procedure.

Step 0: The AMF 2 may initiate the AM Policy Association Establishment procedure by one of the following triggers:
Registration request message is received from the UE 1 with user identifier(s).
The AMF 2 decides to relocate the (V-)PCF 41 as the result of Handover procedure.

Step 1: The AMF 2 decides to establish AM Policy Association with the (V-)PCF 41 where multiple Users per UE 1 (e.g. user identifier(s)) are involved.

Step 2: The AMF 2 sends the Npcf_AMPolicyControl_Create request message to the (V-) PCF 41 with user identifier(s), DNN, App ID, S-NSSAI.

Step 3: The (V-)PCF 41 to apply operator policies for the UE 1 with received user identifier(s).

Step 4: The (V-)PCF 41 sends the Npcf_AMPolicyControl_Create response message specific to the user identifier(s) to the AMF 2.

Step 5: Based on the received Npcf_AMPolicyControl_Create response message specific to the user identifier(s) from the (V-)PCF 41, along with other information, the AMF 2 deploys access and mobility control policy specific to the user identifier(s).

Example Aspect 3: Multi-User UE Policy Association Establishment

This example aspect discloses the following new function to the Multi-User UE Policy Association Establishment.
Multi-User UE Policy Association management for roaming scenario.

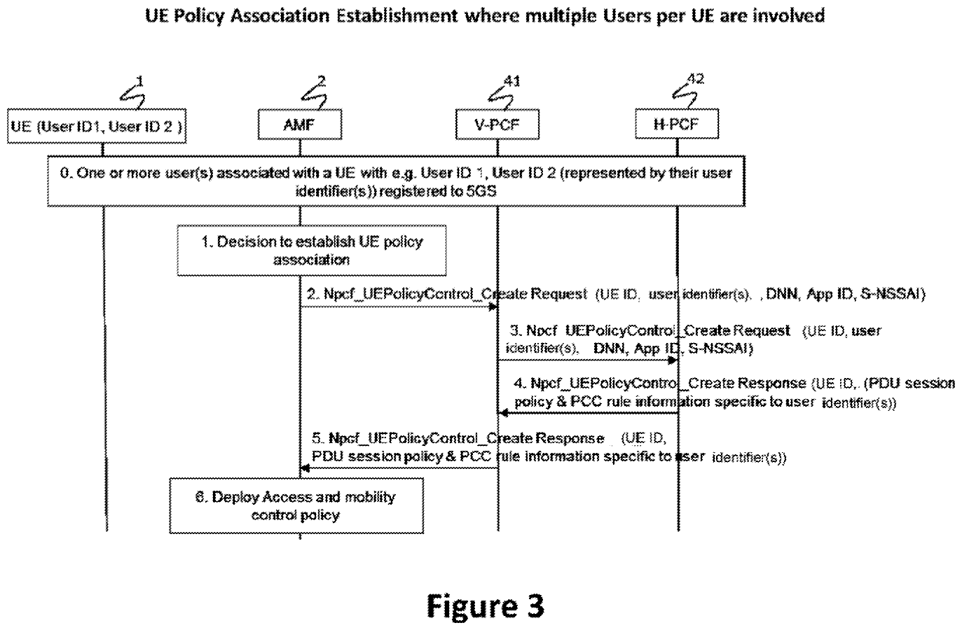

The FIG. 3 explains the flow for the UE Policy Association Establishment where multiple Users per UE 1 are involved.

Step 0: One or more user(s) associated with the UE 1 with e.g. User ID 1, User ID 2 (represented by their user identifier(s)) register to 5GS.

Step 1: The AMF 2 decides to establish policy association e.g. based on a UE Policy Container received from the roaming-in UE 1 in the VPLMN.

Step 2: The AMF 2 sends to the V-PCF 41 the Npcf_UEPolicyControl_Create Request message with user identifier(s), DNN, App ID, S-NSSAI as additional parameters.

Step 3: The V-PCF 41 forwards the Npcf_UEPolicyControl_Create Request message that is received from the AMF 2 in step 2 to the H-PCF 42.

Step 4: The H-PCF 42 updates the UE Policy Association related data per user (i.e. user identifier) basis and sends the Npcf_UEPolicyControl_Create Response (UE ID, PDU session policy & PCC rule information specific to user identifier(s)) message to the V-PCF 41 with PDU session policy & PCC rule information specific to user identifier(s).

Step 5: The V-PCF 41 updates the Policy Control Request Trigger parameters in the V-PCF 41 and forwards the Npcf_UEPolicyControl_Create Response (UE ID, PDU session policy & PCC rule information specific to user identifier(s)) message to the AMF 2 including the Npcf_UEPolicyControl_Create Response (UE ID, PDU session policy & PCC rule information specific to user identifier(s)).

Step 6: The AMF 2 deploys the Access and Mobility policy (AM policy).

Example Aspect 4: Multi-User Charging with AF Influence in Order to Enable Policies and Charging where Multiple Users per UE are Involved

This example aspect discloses the following new function to the Multi-User Charging with the AF 8 influence in order to enable policies and charging where multiple Users per UE 1 are involved.
Application Function influence on traffic routing function will work per UE 1 and associated user identifier(s) basis

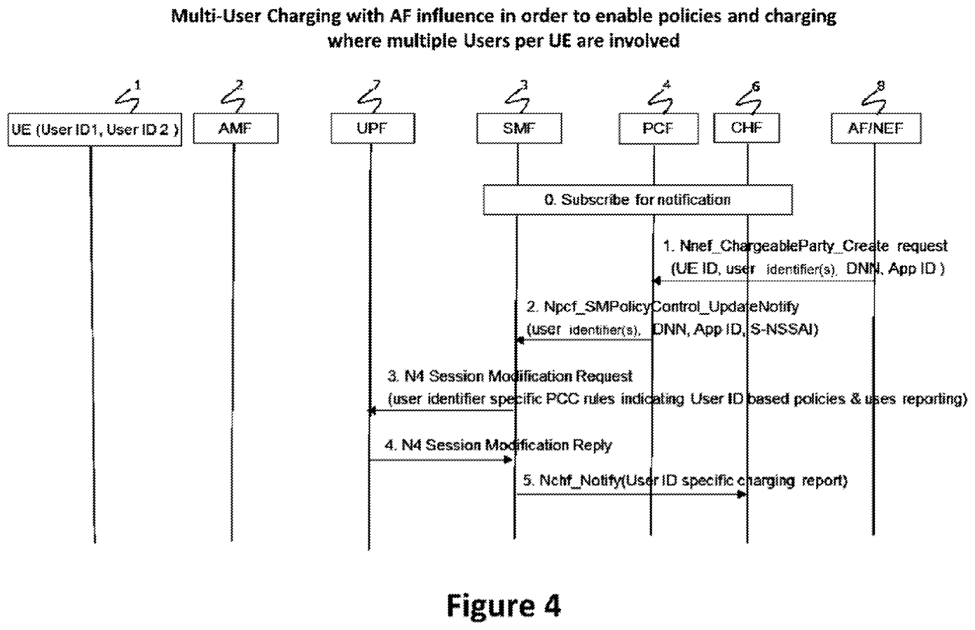

FIG. 4 below shows enhanced procedure where the AF 8 requests to become the chargeable party for the session to be set up by sending the Nnef_ChargeableParty_Create request message.

Step 0: In this scenario, it is assumed that the CHF 6 has been subscribed to User ID (e.g. user identifier(s)) based policies and uses reporting service provided by the SMF 3.

Step 1: The AF 8 sends to the PCF 4 the Nnef_ChargeableParty_Create request message, and additionally includes user identifier(s), DNN, App ID, thus becoming chargeable party for the session.

Step 2: The PCF 4 forwards the received request with corresponding parameters to the SMF 3.

Step 3: The SMF 3 sends a N4 Session Modification Request message with the User ID based (e.g. per user identifier) policies and uses reporting to the UPF 7 where Usage Reporting is configured, thus modifying the Usage Reporting Rules so that the usage collection for charging indicates the User ID (e.g. user identifier), etc.

Step 4: The UPF 7 sends a N4 Session Modification Response message to the SMF 3.

Step 5: The SMF 3 sends the Nchf_Notify message with the User ID (e.g. user identifier) specific charging report to the CHF 6 as the CHF 6 has subscribed to this service.

### SUMMARY

Beneficially, the above described example aspects include, although they are not limited to, one or more of the following functionalities:
New parameters, functionalities and behaviors are proposed to enable charging and policing for use case of multiple user identities per UE. These functionalities and behaviors are:
   1. SM and AM Policy Association Establishment and modification in scenarios where multiple Users per UE are involved. SMF, PCF, CHF, UE interactions, as proposed in above example aspects to ensure appropriate policies and charging at individual User(s) level of granularity
   2. SMF establishes session management policy association enabling PCF to create policies and charging corresponding to one or more user(s) that are sharing or are behind a gateway UE
      a. SMF determining that the PCC authorization is required for requested User identifier(s) and requests to establish an SM Policy Association with the PCF
      b. SMF sending new parameters i.e. user identifier(s) and PDU session ID to PCF
      c. SMF, using N4, applies received PCC rules that enable UPF to uses monitoring and usage reporting with binding to specific user(s)
   3. AMF establishes AM Policy association with PCF where multiple Users per UE are involved
   a. AMF deciding to establish AM Policy Association on receipt of initial registration and/or AMF re-allocation with PCF change in handover procedure and registration procedure with one or more User IDs, and/or based on other criteria
   b. AMF sending new parameters i.e. user identities to PCF

In order to provide these functionalities, the above example aspects describe exemplary methods comprising (at least some of) the following steps:
1. Session Management (SM) Policy Association Establishment and modification procedures are enhanced for use cases where multiple Users per UE are involved. This involves:
   a. SMF determining that the PCC authorization is required for requested User identifier(s) and requests to establish an SM Policy Association with the PCF
   b. SMF provides user identities and PDU session ID to PCF e.g. as additional parameters included in the message Npcf_SMPolicyControl_Create
   c. PCF in turn checks with CHF the policy counter status per User ID and/or PDU session ID
   d. SMF sending accept message to UE OR it sends reject message to UE with SM Policy cause value
2. AM Policy Association Establishment procedures are enhanced for use cases where multiple Users per UE are involved. This involves:
   a. AMF decides to establish AM Policy Association with PCF where multiple Users per UE are involved e.g. if AMF receives initial registration and/or AMF re-allocation with PCF change in handover procedure and registration procedure with one or more User IDs, and/or based on other criteria
   b. AMF sends to PCF new parameters such as User Identities e.g. included as additional parameter to Npcf_AMPolicyControl_Create
3. Procedure to enable AF influence in order to enable policies and charging where multiple Users per UE are involved
   a. Application Function or AF provides user identifier(s), to PCF, in cases where AF requests to become the chargeable party for the session to be set up
   b. SMF notifying CHF indicating data uses corresponding to each User Identities
4. Enhanced procedure UE Policy Association Establishment:
   a. AMF sending to PCF with new parameters user identifier(s), e.g. include them in the message Npcf_UEPolicyControl_Create Request

Benefits

Currently 5GS enables charging on per subscription basis with respective UE ID, and there is no way for 5G systems (PCF, SMF, UPF, AF, CHF) to create, report, manage and/or provide policies and charging information corresponding to different Users sharing this particular UE i.e. policies and charging enabler, to the granularity of individual user identifier(s). The present disclosure proposes example aspects that enable charging and policing for use cases of multiple user identities per UE.

System Overview

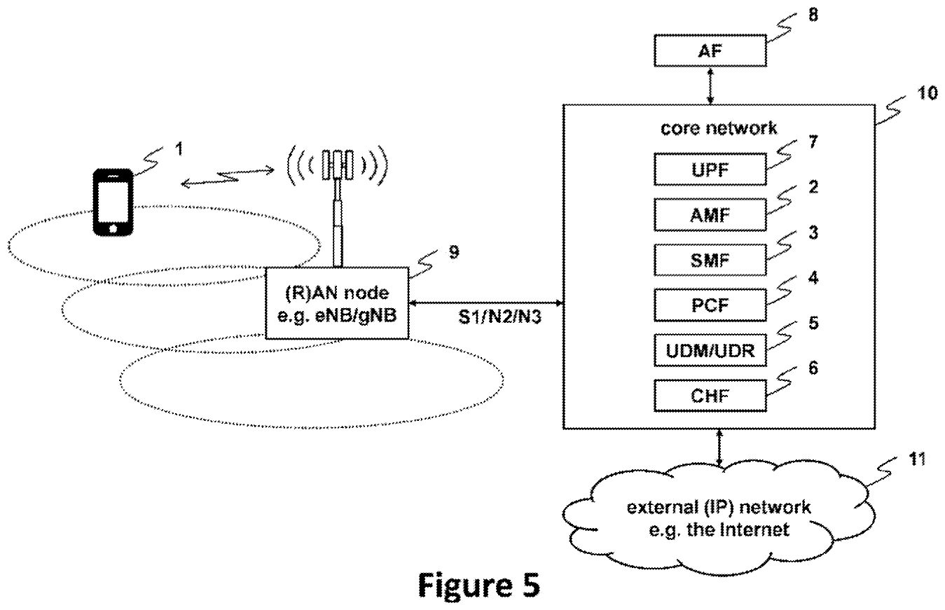

FIG. 5 schematically illustrates a mobile (cellular or wireless) telecommunication system to which the above example embodiments are applicable.

In this network, users of mobile devices 1 (UEs) can communicate with each other and other users via respective base stations 9 and a core network 10 using an appropriate 3GPP radio access technology (RAT), for example, an E-UTRA and/or 5G RAT. It will be appreciated that a number of base stations 9 form a (radio) access network or (R)AN. As those skilled in the art will appreciate, whilst one mobile device 1 and one base station 9 are shown in FIG. 5 for illustration purposes, the system, when implemented, will typically include other base stations and mobile devices (UEs).

Each base station 9 controls one or more associated cells (either directly or via other nodes such as home base stations, relays, remote radio heads, distributed units, and/or the like). A base station 9 that supports E-UTRA/4G protocols may be referred to as an ‘eNB’ and a base station 9 that supports Next Generation/5G protocols may be referred to as a ‘gNBs’. It will be appreciated that some base stations 9 may be configured to support both 4G and 5G, and/or any other 3GPP or non-3GPP communication protocols.

The mobile device 1 and its serving base station 9 are connected via an appropriate air interface (for example the so-called ‘Uu’ interface and/or the like). Neighbouring base stations 9 are connected to each other via an appropriate base station to base station interface (such as the so-called ‘X2’ interface, ‘Xn’ interface and/or the like). The base station 9 is also connected to the core network nodes via an appropriate interface (such as the so-called ‘S1’, ‘N2’, ‘N3’ interface, and/or the like).

The core network 10 typically includes logical nodes (or ‘functions’) for supporting communication in the telecommunication system. Typically, for example, the core network 10 of a ‘Next Generation’/5G system will include, amongst other functions, control plane functions (CPFs) and user plane functions (UPFs) 7. It will be appreciated that the core network 10 may also include, amongst others: an Access and Mobility Management Function (AMF) 2; a Session Management Function (SMF) 3; a Policy Control Function (PCF) 4; a Unified Data Management/Unified Data Repository (UDM/UDR) 5; and a Charging Function (CHF) 6.

An Application Server (AF) 8 may also be provided within the core network 10 or coupled to the core network 10. From the core network 10, connection to an external IP network 11 (such as the Internet) is also provided.

The components of this system are configured to perform one or more of the above described exemplary embodiments.

User Equipment (UE)

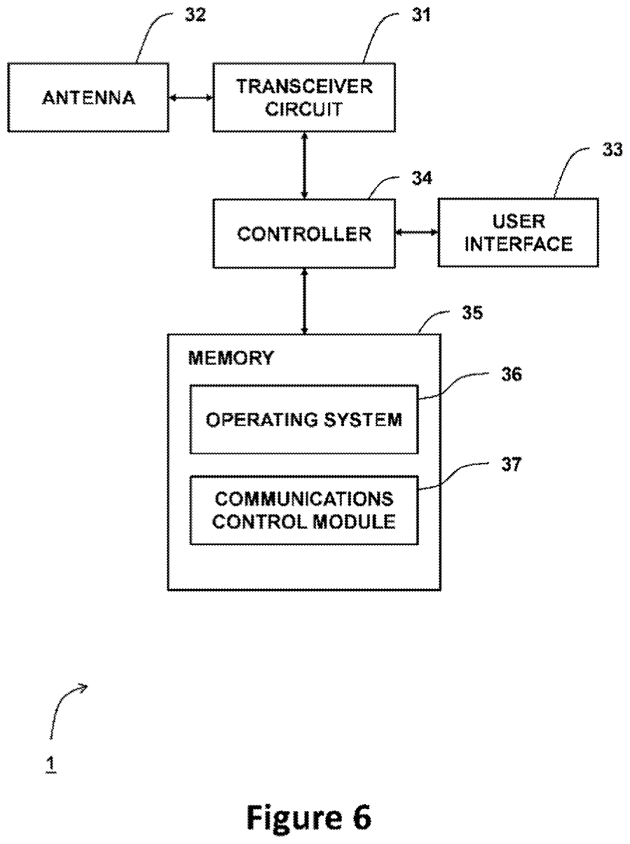

FIG. 6 is a block diagram illustrating the main components of the UE (mobile device 1) shown in FIG. 5. As shown, the UE 1 includes a transceiver circuit 31 which is operable to transmit signals to and to receive signals from the connected node(s) via one or more antenna 32. Although not necessarily shown in FIG. 6, the UE 1 will of course have all the usual functionality of a conventional mobile device (such as a user interface 33) and this may be provided by any one or any combination of hardware, software and firmware, as appropriate. A controller 34 controls the operation of the UE 1 in accordance with software stored in a memory 35. The software may be pre-installed in the memory 35 and/or may be downloaded via the telecommunication network or from a removable data storage device (RMD), for example. The software includes, among other things, an operating system 36 and a communications control module 37. The communications control module 37 is responsible for handling (generating/sending/receiving) signalling messages and uplink/downlink data packets between the UE 1 and other nodes, including (R)AN nodes 9, core network nodes, and application functions. Such signaling includes appropriately formatted requests and responses relating to charging for one or more user identities.

(R)AN Node

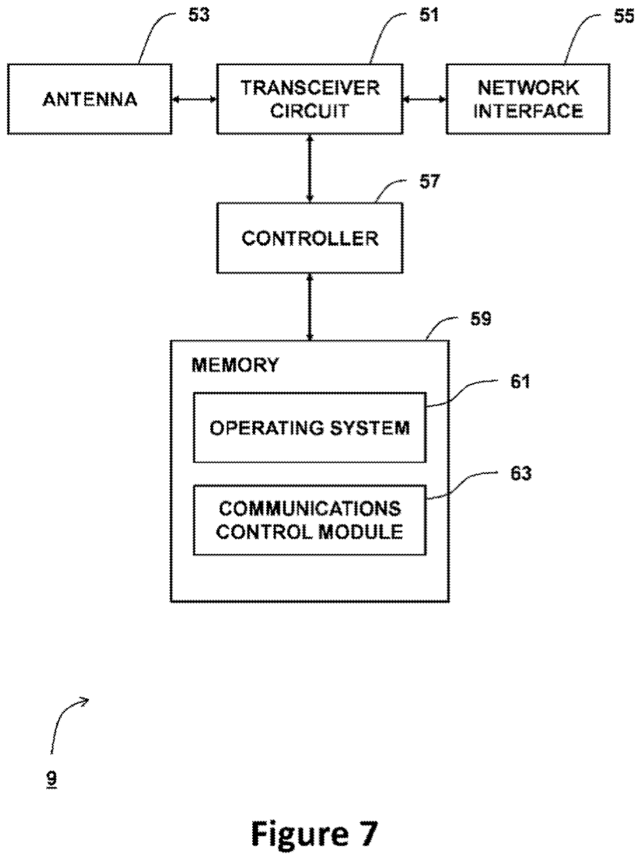

FIG. 7 is a block diagram illustrating the main components of an exemplary (R)AN node 9 (base station) shown in FIG. 5. As shown, the (R)AN node 9 includes a transceiver circuit 51 which is operable to transmit signals to and to receive signals from connected UE(s) 1 via one or more antenna 53 and to transmit signals to and to receive signals from other network nodes (either directly or indirectly) via a network interface 55. The network interface 55 typically includes an appropriate base station—base station interface (such as X2/Xn) and an appropriate base station—core network interface (such as S1/N2/N3). A controller 57 controls the operation of the (R)AN node 9 in accordance with software stored in a memory 59. The software may be pre-installed in the memory 59 and/or may be downloaded via the telecommunication network or from a removable data storage device (RMD), for example. The software includes, among other things, an operating system 61 and a communications control module 63. The communications control module 63 is responsible for handling (generating/sending/receiving) signalling between the (R)AN node 9 and other nodes, such as the UE 1 and the core network nodes/application functions. Such signaling includes appropriately formatted requests and responses relating to charging for one or more user identities.

Core Network Node

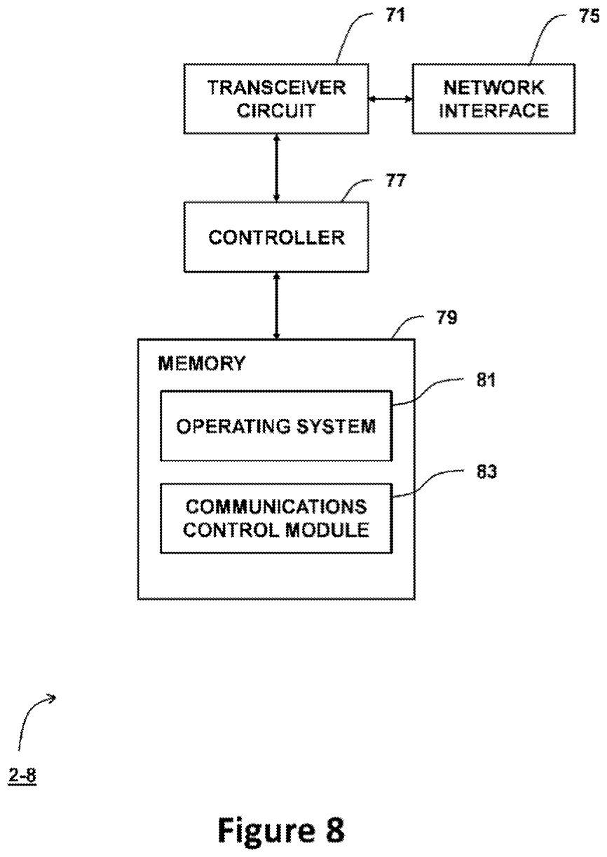

FIG. 8 is a block diagram illustrating the main components of a generic core network node (or function) shown in FIGS. 1 to 5, for example, the AMF 2, the SMF 3, the PCF 4, the UDM/UDR 5, the CHF 6, and the UPF 7. It will be appreciated that the same block diagram may be applicable to the AF 8 as well. As shown, the core network node includes a transceiver circuit 71 which is operable to transmit signals to and to receive signals from other nodes (including the UE 1 and the (R)AN node 9) via a network interface 75. A controller 77 controls the operation of the core network node in accordance with software stored in a memory 79. The software may be pre-installed in the memory 79 and/or may be downloaded via the telecommunication network or from a removable data storage device (RMD), for example. The software includes, among other things, an operating system 81 and at least a communications control module 83. The communications control module 83 is responsible for handling (generating/sending/receiving) signaling between the core network node and other nodes, such as the UE 1, (R)AN node 9, the AFs 8, and other core network nodes. Such signaling includes appropriately formatted requests and responses relating to charging for one or more user identities.

Modifications and Alternatives

Detailed example embodiments have been described above. As those skilled in the art will appreciate, a number of modifications and alternatives can be made to the above example embodiments whilst still benefiting from the inventions embodied therein. By way of illustration only a number of these alternatives and modifications will now be described.

In the above description, the UE, the (R)AN node, and the core network node are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (10) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE, the (R)AN node, and the core network node as a signal over a computer network, or on a recording medium. Further, the functionality performed by part or all of this software may be performed using one or more dedicated hardware circuits. However, the use of software modules is preferred as it facilitates the updating of the UE, the (R)AN node, and the core network node in order to update their functionalities.

The above embodiments are also applicable to ‘non-mobile’ or generally stationary user equipment.

Various other modifications will be apparent to those skilled in the art and will not be described in further detail here.

### List of References stated in the present specification

[1] 3GPP TR 21.905: “Vocabulary for 3GPP Specifications”. V16.0.0 (2019-06-11)

[2] 3GPP TS 23.501: “System Architecture for the 5G System; Stage 2”. V16.0.0 http://www.3gpp.org/ftp/Specs/archive/23_series/23.501/23501-f40.zip

[3] 3GPP TS 23.502: “Procedures for the 5G System; Stage 2” V16.0.0 http://www.3gpp.org/ftp/Specs/archive/23_series/23.502/23502440.zip

[4] New SID: SA2 Study item on the Usage of User Identifiers in the 5G System (FS_UU15) S2-1906717

[5] SA1 TR 22.904 Study on user centric identifiers and authentication http://www.3gpp.org/ftp/Specs/archive/22_series/22.904/22904-g10.zip

This application is based upon and claims the benefit of priority from European Patent Application No. 19208398.8, filed on Nov. 11, 2019, the disclosure of which are incorporated herein in their entirety by reference.

### REFERENCE SIGN LIST

1 MOBILE DEVICE (UE)

2 AMF

3 SMF

4 PCF

5 UDM/UDR

6 CHF

7 UPF

8 AF

9 (R)AN node

10 core network

11 external IP network

31 TRANSCEIVER CIRCUIT

32 ANTENNA

33 USER INTERFACE

34 CONTROLLER

35 MEMORY

36 OPERATING SYSTEM

37 COMMUNICATIONS CONTROL MODULE

51 TRANSCEIVER CIRCUIT

53 ANTENNA

55 NETWORK INTERFACE

57 CONTROLLER

59 MEMORY

61 OPERATING SYSTEM

63 COMMUNICATIONS CONTROL MODULE

71 TRANSCEIVER CIRCUIT

75 NETWORK INTERFACE

77 CONTROLLER

79 MEMORY

81 OPERATING SYSTEM

83 COMMUNICATIONS CONTROL MODULE

What is claimed is:

1. A network function node in a core network, comprising:
a memory storing instructions; and
one or more processors configured to execute the instructions to:
receive, from User Equipment, UE, a non access stratum, NAS, message including identity information for the UE, and a plurality of user identity information, each of which includes a user identifier for a user that uses the UE; and
send, to a policy control and charging function node in the core network, the plurality of the user identity information for creating a Policy and Charging Control, PCC, rule based on the plurality of the user identity information.

2. The network function node according to claim 1, wherein
the network function node includes a Session Management Function node, the NAS message includes a Protocol Data Unit, PDU, session identity, ID, the one or more processors are configured to send, to the policy control and charging function node, the PDU session ID and the plurality of the user identity information for creating the PCC rule based on the PDU session ID and the plurality of the user identity information.

3. The network function node according to claim 2, wherein:
the one or more processors are configured to
receive, from the policy control and charging function node, the PCC rule; and
determine whether the NAS message is accepted or rejected based on the PCC rule.

4. The network function node according to claim 2, wherein:
the one or more processors are configured to
receive a request for notifying an event from an application function node or a network exposure function node via the policy control and charging function node, wherein the request includes the identity information for the UE, and the plurality of user identity information;
send a session modification request message corresponding to the session ID and one of the plurality of user identity information, to a user plane function node in the core network;
receive a session modification response message from the user plane function node; and
send a notification message with the one of the plurality of user identity information to a charging function node in the core network.

5. The network function node according to claim 1, wherein
the network function node includes an access and mobility management node, the NAS message includes a Single-Network Slice Selection Assistance Information, S-NSSAI,
the one or more processors are configured to send, to the policy control and charging function node, the S-NSSAI and the plurality of the user identity information for creating the PCC rule based on the S-NSSAI and the plurality of the user identity information.

6. The network function node according to claim 5, wherein:
the one or more processors are configured to
receive, from the policy control and charging function node, the PCC rule; and
determine whether the NAS message is accepted or rejected based on the PCC rule.

7.-10. (canceled)

11. A method for a network function node in a core network, the method comprising:
receiving, from User Equipment, UE, a non access stratum, NAS, message including identity information for the UE, and a plurality of user identity information, each of which includes a user identifier for a user that uses the UE; and
sending, to a policy control and charging function node in the core network, the plurality of the user identity information for creating a Policy and Charging Control, PCC, rule based on the plurality of the user identity information.

12. The method according to claim 11, wherein
the NAS message includes a Protocol Data Unit, PDU, session identity, ID, and the sending includes sending, to the policy control and charging function node, the PDU session ID and the plurality of the user identity information for creating the PCC rule based on the PDU session ID and the plurality of the user identity information.

13. The method according to claim 12, further comprising:
receiving, from the policy control and charging function node, the PCC rule; and
determining whether the NAS message is accepted or rejected based on the PCC rule.

14. The method according to claim 12, further comprising:
receiving a request for notifying an event from an application function node or a network exposure function node via the policy control and charging function node, wherein the request includes the identity information for the UE, and the plurality of user identity information;
sending a session modification request message corresponding to the session ID and one of the plurality of user identity information, to a user plane function node in the core network;
receiving a session modification response message from the user plane function node; and
sending a notification message with the one of the plurality of user identity information to a charging function node in the core network.

15. The method according to claim 11, wherein
the NAS message includes a Single-Network Slice Selection Assistance Information, S-NSSAI,
the sending includes sending, to the policy control and charging function node, the S-NSSAI and the plurality of the user identity information for creating the PCC rule based on the S-NSSAI and the plurality of the user identity information.

16. The method according to claim 15, further comprising:
receiving, from the policy control and charging function node, the PCC rule; and
determining whether the NAS message is accepted or rejected based on the PCC rule.

17. A method for a policy control and charging function node in a core network, the method comprising:
receiving, from a network function node in the core network, a plurality of a user identity information, each of which includes a user identifier for a user that uses user equipment, UE;
creating a Policy and Charging Control, PCC, rule based on the plurality of the user identity information; and
sending, to the network function node, the PCC rule.

18. The method according to claim 17, wherein
the receiving includes receiving, from the network function node, a Protocol Data Unit, PDU, session identity, ID, and the plurality of the user identity information, and the creating includes creating the PCC rule based on the PDU session ID and the plurality of the user identity information.

19. The method according to claim 18, further comprising:
receiving a request for notifying an event from an application function node or a network exposure function node, wherein the request includes an identity information for the UE, and the plurality of user identity information; and
sending the request to the network function node.

20. The method according to claim 17, wherein
the receiving includes receiving, from the network function node, a Single-Network Slice Selection Assistance Information, S-NSSAI, and the plurality of the user identity information, and
the creating includes creating the PCC rule based on the S-NSSAI and the plurality of the user identity information.
